(19) United States
(12) Patent Application Publication
(10) Pub. No.: US 2025/0315204 A1
(43) Pub. Date: Oct. 9, 2025

(54) Cold Start Playback Recommendations

(71) Applicant: Sonos, Inc., Goleta, CA (US)

(72) Inventors: Dayn WILBERDING, Santa Barbara, CA (US); King Shy GOH, Santa Barbara, CA (US)

(21) Appl. No.: 19/088,480

(22) Filed: Mar. 24, 2025

Related U.S. Application Data
(60) Provisional application No. 63/575,064, filed on Apr. 5, 2024.

(51) Int. Cl. G06F 3/16; G06F 16/435; G06F 16/438

(52) U.S. Cl. CPC G06F 3/165; G06F 16/435; G06F 16/438

(57) ABSTRACT

A service for providing playback recommendations is disclosed. The service receives data corresponding to one or more inputs and/or commands associated with a media playback system and provides one or more playback recommendations for a new service registered with the media playback system.

### CROSS-REFERENCE TO RELATED APPLICATIONS

This application claims the benefit of priority to U.S. Provisional Patent Application No. 63/575,064 filed on 5 Apr. 2024 and entitled “Cold Start Playback Recommendations,” the contents of which are incorporated by reference herein in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partial schematic diagram of a control device.

FIG. 2 illustrates a block diagram of one or more systems, in accordance with embodiments described herein.

FIG. 3 illustrates a flowchart for a set of methods of providing playback recommendations for a new service based on interactions with another service, in accordance with embodiments described herein.

FIG. 4A illustrates examples of log data that can be generated and/or registered by a primary service, in accordance with embodiments described herein.

FIG. 4B illustrates an example user-item matrix, in accordance with embodiments described herein.

FIG. 4C illustrates an example prediction matrix, in accordance with embodiments described herein.

FIG. 5 illustrates a flowchart for a set of example methods of providing playback recommendations based on one or more inputs and/or commands, in accordance with embodiments described herein.

FIG. 6A illustrates an example of a first user interface via which inputs/commands can be received, in accordance with embodiments described herein.

FIG. 6B illustrates an example of a second user interface via which one or more recommendations can be provided, in accordance with embodiments described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Users often benefit from content recommendations offered by content providers. These content recommendations are usually provided based on previous interactions, such as previous content consumption and/or preferences previously indicated by the users. However, when a user first starts using a service, the service provider may not have enough or any information about this user to provide personalized content recommendations. This challenge is sometimes referred to as the “cold start” problem in the field of recommendation systems.

In order to address these challenges, many services include preference surveys as part of their registration or onboarding process. During this process, a user may be able to indicate at least a type of content they like (or do not like). For example, a user can select up to 3 artists that the user likes or rate a set of movies based on the user's preferences. This set of initial data can then be used by the service to provide an initial set of recommendations. However, this process typically requires time and effort from the user and does not usually result in meaningful recommendations.

Another option can include providing cold start recommendations based on demographics that apply to the particular user. For example, a service may recommend content based on user profile data, such as the user age or region. The content can include content that other users with similar demographics typically consume. However, this process also does not usually result in meaningful recommendations because what is relevant for one user may not be for another, even if they have some common demographic information.

Therefore, providing cold start recommendations continues to be a challenge.

One potential solution comprises providing recommendations based on previous interactions with other services, including different service types. However, cross-service recommendations can be challenging for various reasons. Different services, especially services provided by different content providers, may not be designed to share data with each other. Furthermore, service providers may prevent other services from accessing and/or using their data for certain purposes such as to provide recommendations. Therefore, cross-service recommendations can be hard to implement.

Embodiments described herein relate to a primary service capable of providing cold start recommendations for secondary services, and techniques for providing cold start recommendations for the secondary services leveraging interactions with the primary service. In some embodiments, for example, a primary service such as a media playback system service is provided for a media playback system. Secondary services such as streaming services can be associated with the media playback system and/or the media playback system service. When a new secondary service is added to the set of secondary services, cold start recommendations can be provided based on previous interactions with the primary service and/or media playback system. At the same time, each of the secondary services can independently manage and control their respective data about user interactions and provide recommendations accordingly.

For example, a user can interact with a first service to manage certain aspects of the media playback system such as to search content for playback, to set or change playback configurations such as grouping of playback devices, volume, etc. These interactions can be registered and used with a machine learning algorithm to infer user preferences and/or routines. The inferred preferences and/or routines can be used by a recommender system to generate one or more playback recommendations for a second service. The recommender system can have access to a catalog of content available at the second service so as to provide media content recommendations. The playback recommendations can include the media content recommendations and playback configuration recommendations inferred by the first service. In this way, a user can start using a new service with their media playback system with an initial set of playback recommendations that corresponds to the user actual use of the media playback system.

In some embodiments, for example, a computing system is provided. The computing system comprises at least one processor and at least one non-transitory computer-readable medium comprising program instructions that are executable by the at least one processor such that the computing system is configured to: receive, via a first service registered with a media playback system, a first input comprising one or more search terms; after receiving the first input: (i) store first data corresponding to the input, and (ii) provide one or more search results based on the search terms, wherein the one or more search results comprise indications of media content available at one or more streaming services registered with the media playback system; receive, via the first service, a second input indicating a playback configuration for the media playback system; and after receiving the second input: (i) store second data corresponding to the second input; and (ii) cause the media playback system to implement the playback configuration; detect that a new streaming service has been registered with the media playback system, wherein the new streaming service is different from the one or more streaming services; and based on the first data and the second data, generate one or more playback recommendations for the new media streaming service, wherein the one or more playback recommendations comprise at least one media content recommendation based on the search terms and at least one playback configuration recommendation based on the playback configuration.

In some embodiments, for example, a computing system is provided. The computing system comprises at least one processor and at least one non-transitory computer-readable medium comprising program instructions that are executable by the at least one processor such that the computing system is configured to: receive, via a voice user interface of a playback device of a media playback system, a voice command for the media playback system; process the voice command using one or more services associated with the media playback system; store data corresponding to the voice command; cause the media playback system to take one or more actions in response to the voice command; detect that a media streaming service has been registered with the media playback system, wherein the media streaming service is independent and distinct from the one or more services associated with the media playback system; based on the log data, generate one or more playback recommendations for the media streaming service; and provide the one or more playback recommendations via a user interface of the media streaming service, wherein the user interface of the media streaming service is independent and distinct from the voice user interface of the playback device.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

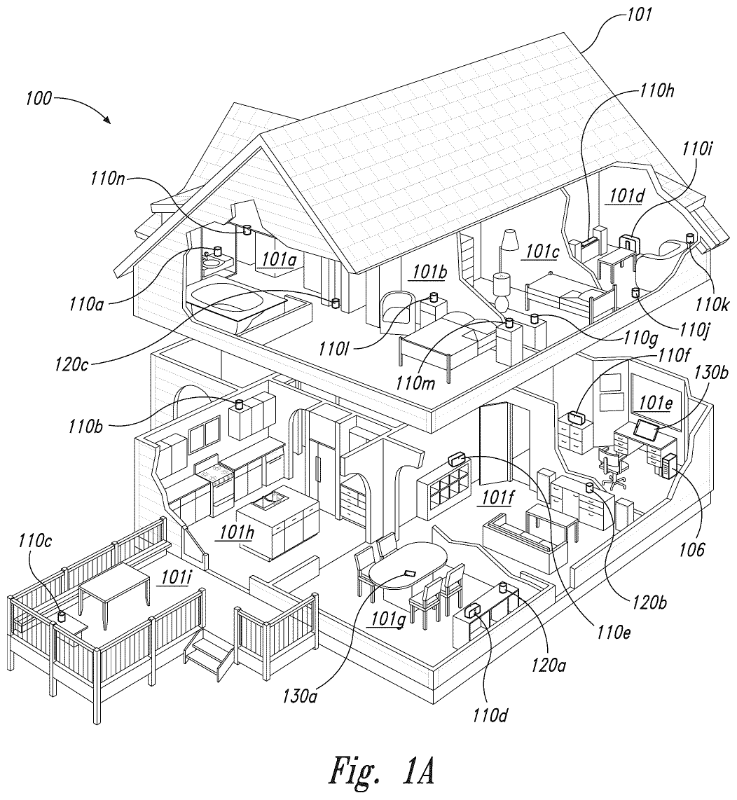

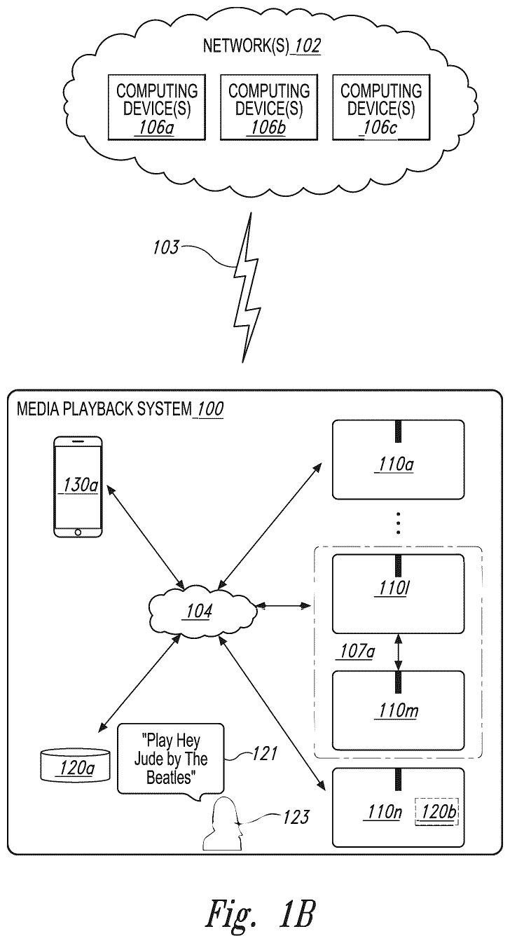

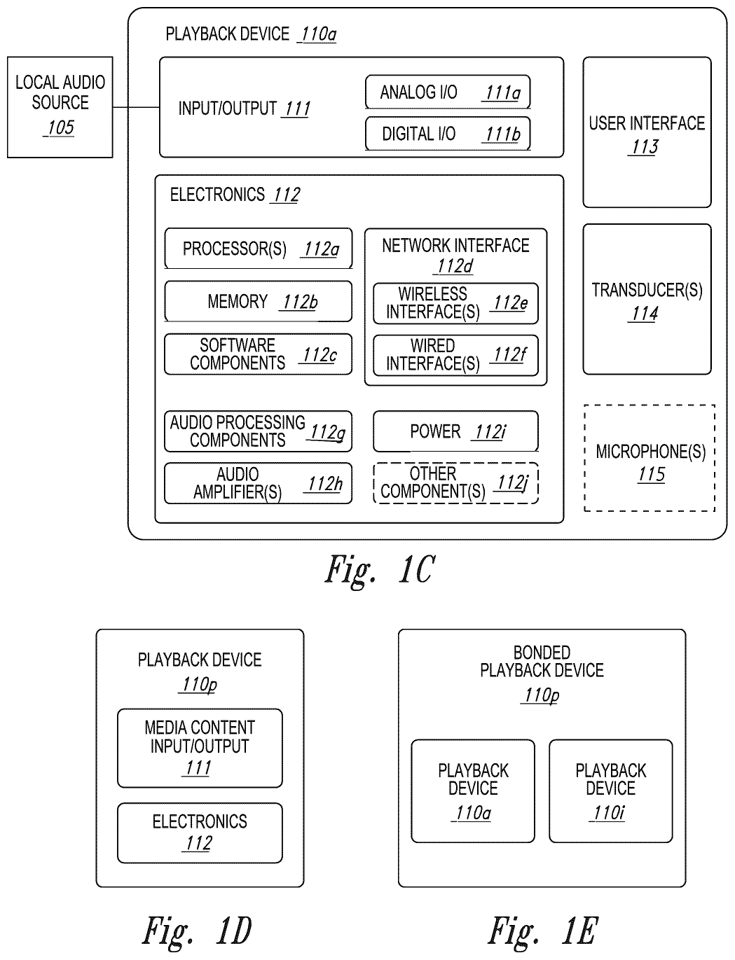

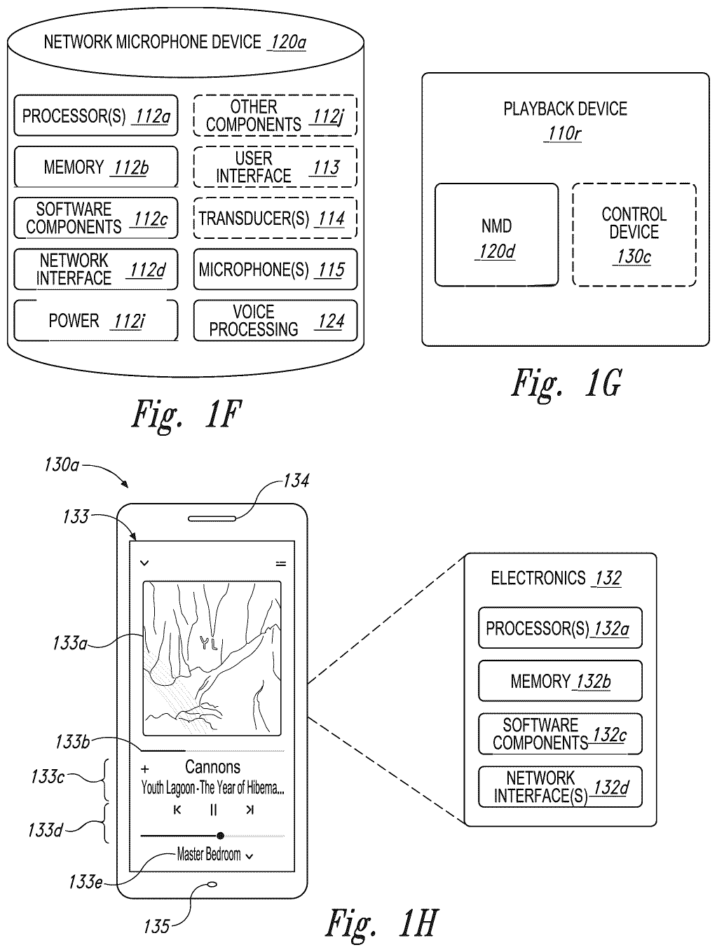

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

### a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: MP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 1101 and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Cold Start Playback Recommendations

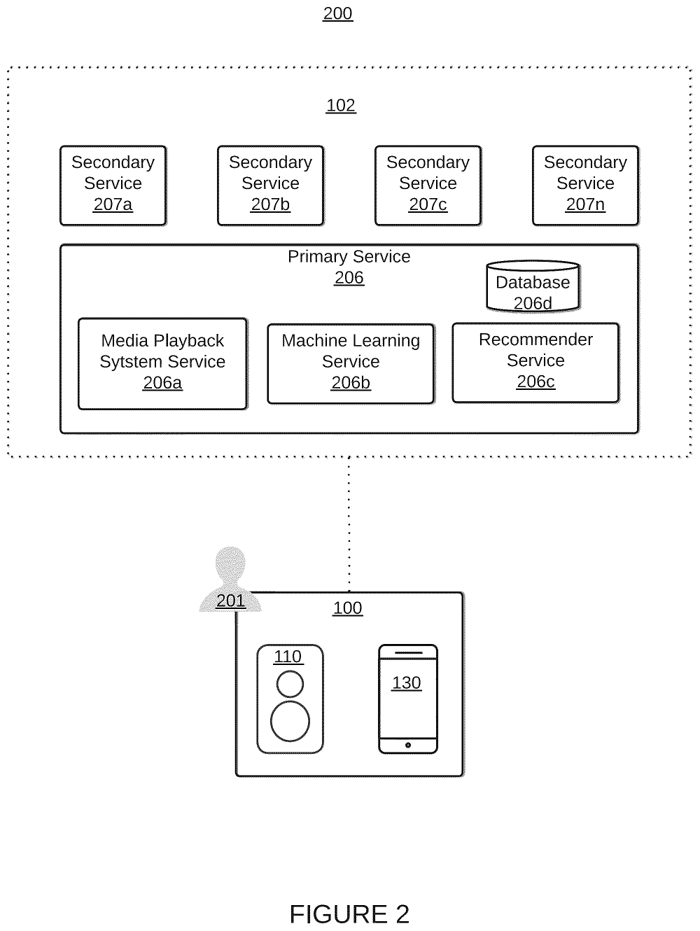

FIG. 2 illustrates a block diagram 200 of one or more systems, in accordance with embodiments described herein. Block diagram 200 illustrates an example media playback system, such as media playback system 100 described with reference to FIGS. 1A-1H, and an example cloud network, such as cloud network 102 also described with reference to FIGS. 1A-1H. As described before, the media playback system 100 can comprise one or more playback devices 110 and/or one or more control devices 130, among other devices. As also described before, cloud network 102 can comprise one or more computing systems and/or computing devices configured to provide one or more services. As an example, block diagram 200 illustrates a primary system and/or service 206 and a set of secondary systems and/or services including secondary systems/services 207a, 207b, 207c . . . 207n, collectively referred to as secondary systems/services 207. Any number of systems/services can be possible. Each of these systems/services can be provided by/via one or more of the computing system/devices 106 described with reference to FIG. 1B, individually or in combination. The media playback system 100, the primary service and/or any of the secondary services can be associated/registered with one or more user accounts of a user (or family of users) 201. Even though the services 206 and 207 are represented in FIG. 2 as part of cloud network 102, any of the services can be provided (at least in part) locally by the media playback system 100.

The primary service 206 can comprise one or more of a media playback system service 206a, a machine learning service 206b, and a recommender service 206c. The media playback system service 206a can be a service that facilitates access and control of the media playback system. The media playback system service can comprise a first party, native, and/or proprietary service provided by the provider of the media playback system 100. The primary service can be accessed via a control device 130 of the media playback system, a software application installed on a user device, a web portal, or any other suitable means. The primary service can comprise a service that is configured to receive and handle user inputs and interact with one or more of the secondary services to conduct actions triggered by and/or associated with the user inputs (e.g., actions to fulfill the user intent). In some instances, the media playback system service comprises one or more of: a playback control service, a content management service, a content search service, a voice assistant service, a content source such as a content storage and/or streaming service, or any other service suitable for a media playback system. The machine learning service 206b and/or the recommender service 206c can be configured to provide respective inferences and recommendations based on data available to the primary service, as will be explained below in more detail. In some instances, the machine learning service 206b and/or the recommender service 206c can be associated with (e.g., part of and/or provided by) the media playback service 206a.

The secondary services 207 can comprise one or more content sources such as content storage and/or media streaming services. One or more of the secondary services can comprise first party and/or proprietary services provided by the provider of the media playback system 100. One or more of the secondary services can comprise third party and/or external services provided by providers different than the provider of the media playback system 100. The secondary services can be accessed via a user device such as control device 130 of the media playback system, a software application installed on a user device, a web portal, or any other suitable means.

In some instances, each of the primary service and/or secondary services provide their own, independent control means. For example, each of the services can have their own controller application that can be accessed independently. In some instances, each of the primary service 206 and/or secondary services 207 are associated with and/or can be accessed through respective user accounts. In this way, a user 201 can create one or more user accounts to access any of the primary service 206 and/or secondary services 207.

In some instances, the secondary services can be associated with the media playback system and/or primary service 206. The secondary services can be associated with the primary service and/or the media playback system in various ways. Example techniques are described in U.S. Pat. No. 8,910,265, filed Sep. 28, 2012, entitled “Assisted Registration of Audio Sources”, and U.S. Pat. No. 9,787,739B2, filed Apr. 23,2015, entitled “Social Network Account Assisted Service Registration”, which are incorporated herein by reference in their entireties. Registering a service with the media playback system can comprise receiving authentication information associated with the user of the service, and registering the service according to the received authentication information. In some instances, the user can register the services with the media playback system and/or primary service by registering any respective accounts with the media playback system. For example, the user can provide credentials of the accounts via a user interface of media playback systems and/or primary service, and go through an authentication process to authenticate the user and/or credentials.

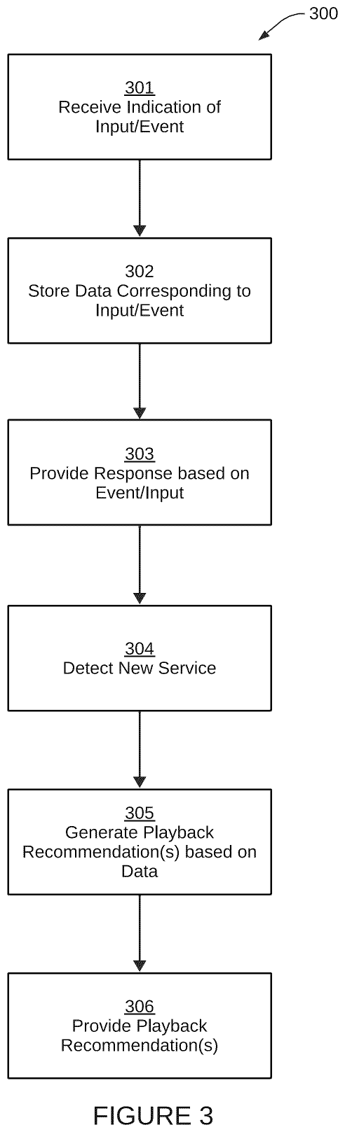

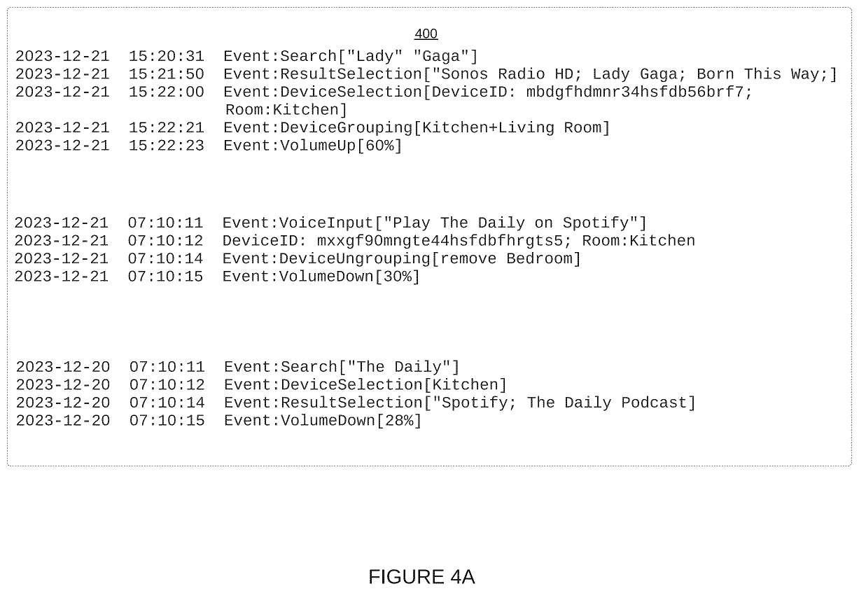

The primary service 206 can be used to manage multiple aspects of the media playback system 100, including any secondary service(s) 207. Therefore, the primary service can be used as an intermediary service between the media playback system and the secondary services, so that a user of the media playback system has a centralized service that facilitates access to content and/or functionalities provided by the primary service and/or any of the secondary services 207. The primary service can offer a set of functionalities that are independent of any functionality offered by the secondary services. Furthermore, the primary service can register data (e.g., receive and/or store data in the form of logs or events) of any interactions with the functions provided by the primary service. As will be explained in more detail with reference to FIG. 3, when a new secondary service is added to the set of secondary services 207, the primary service can then leverage user interactions with the primary service to facilitate a set of initial playback recommendations for the new service, without compromising data “owned” or otherwise corresponding to any of the other secondary services.

FIG. 3 illustrates a flowchart for a set of methods of providing playback recommendations for a new service (e.g., a new primary or secondary service) based on interactions with another service (e.g., the primary service), in accordance with embodiments described herein.

At block 301, flowchart 300 comprises receiving one or more indications corresponding to an event. The event can be an event related to the primary service 106 and/or media playback system 100. In some instances, the event comprises receiving an input. The input can be received via a user interface of a first service such as primary service 206 and/or a user interface of the media playback system 100. In some instances, receiving the input in block 301 comprises detecting the input (e.g., a touch, a selection, a voice input, etc.) via the user interface. In some instances, receiving the input in block 301 comprises receiving data corresponding to the input. For example, an input processing module (e.g., one or more of the software components 132c described with reference to FIG. 1H) can be configured to detect and/or process the input and generate data corresponding to the input. Processing the input can comprise “translating” the input to data that the system can use (e.g., speech to text, button touch to digital coordinates/data, etc.). Processing the input can comprise parsing the input or data representing the input to detect, identify and/or extract relevant information such as commands and/or any of the search terms, playback configurations and/or descriptors mentioned before. This data can then be passed on to the corresponding processing modules of the media playback system 100 and/or primary service 206.

In some instances, the input indicates a command to be executed by the media playback system and/or the primary service 206, such as a playback command. For example, the input can comprise an input to start/stop playback, to skip a media item, to set or adjust settings/configurations, to add a media item to a playback queue, etc.

In some instances, the input comprises descriptors of media content. For example, the input can comprise and/or indicate media content metadata such as a media item title, an artist name, an album name, a genre, a mood, etc. In some instances, the descriptors can be used as search terms and/or to derive/infer search terms to search for media content.

In some instances, the input comprises one or more search terms to search for media content. The search terms can be typed, spoken, selected, or otherwise indicated by a user via the user interface. In some instances, the search terms are explicitly indicated in the input. For example, a user can input a song title or an artist name as a search term. In some instances, the search terms can be derived/inferred from the input. For example, the search terms can comprise a portion of a title from which a full title can be inferred, or a misspelled artist name from which an artist name can be inferred. In some instances, the input can comprise additional data other than the search terms.

In some instances, the input comprises indications of one or more playback configurations. A playback configuration can comprise any configuration or settings of the media playback system. For example, the input can indicate one or more playback devices where media content is to be played back, a volume at which media content is to be played back, equalization settings for the media playback system, a room where media content is to be played back, a lighting configuration for the room, etc.

In some instances, the input comprises an input received via a control interface of a control device such as control device 130. The user interface can comprise a graphical user interface displayed via a display of the control device 130 such as such as user interface 133 described with reference to FIG. 1H. For example, the input can be in the form of a touch selection of a media item for playback. The user interface can alternatively or in combination comprise a physical user interface of the control device 130. For example, the input can be in the form of a physical button touch to adjust the volume. The input can include indications of any of the commands, descriptors, search terms and/or playback configurations described above.

In some instances, the input comprises an input received via a user interface of a playback device such as playback device 110. The user interface can comprise a graphical user interface displayed on a display of the playback device. For example, the input can be in the form of a touch selection of a media item for playback. The user interface can alternatively or in combination comprise a physical user interface of the playback device 110. For example, the input can be in the form of a physical button touch to adjust the volume. The input can include indications of any of the commands, descriptors, search terms and/or playback configurations described above.

In some instances, the input comprises a voice command. The voice command can be received via a voice user interface of one or more devices of the media playback system. For example, the voice command can be received via microphones on any of the playback devices 110 and/or control devices 130. The voice command can include indications of any of the commands, descriptors, search terms and/or playback configurations described above.

At block 302, flowchart 300 comprises storing data corresponding to the event and/or input. The data can comprise any data corresponding to the events such as an indication or description of the event received. In some instances, the data comprises contextual data corresponding to the event. The contextual data can comprise any data indicative of the context in which the event was received, such as a time, a date, a location, a media playback system configuration being used for playback, including for example indicators and/or identifiers of any playback devices or group of playback devices used for playback, the playback volume, equalization settings, etc. In some instances, the data comprises indications of any command, descriptor, search term and/or playback configurations indicated in the event. For example, the data can comprise indications of media content metadata such as a media item name, an artist name, an album name, a genre, a mood, etc.

In some instances, storing the data in block 302 comprises generating at least part of the data based on and/or in response to the event. The data can be generated in response to any event occurring in the media playback system and/or primary service 206. The data can include a register or record of events comprising data such as the time of the event, the type of event, identifiers associated with the event such as media playback system identifier, a user identifier, etc. In some instances, the data can be in the form of logs. The computing system can comprise one or more log generator software modules configured to generate logs in response to the various events. The log generator can be configured to include any suitable data in the generated logs. In some instances, the data can be stored in any other form such as data structures in a database. The data can be processed by one or more data processing modules in order to store the data in a more structured format. This data can be queried from the database in different ways to obtain different views on different aspects of the data as desired. Examples of data processing and data extraction methods related to events are described in U.S. Pat. No. 11,675,786, filed Mar. 31, 2020, entitled “Systems and Methods for Extracting Data Views from Heterogeneous Sources”, which is incorporated by reference herein in its entirety.

In some instances storing data in block 302 can comprise storing the data in a storage accessible to the primary service 206. For example, storing the data can comprise storing the data in a database associated with the primary service, such as database 206d, or causing the database to store the data.

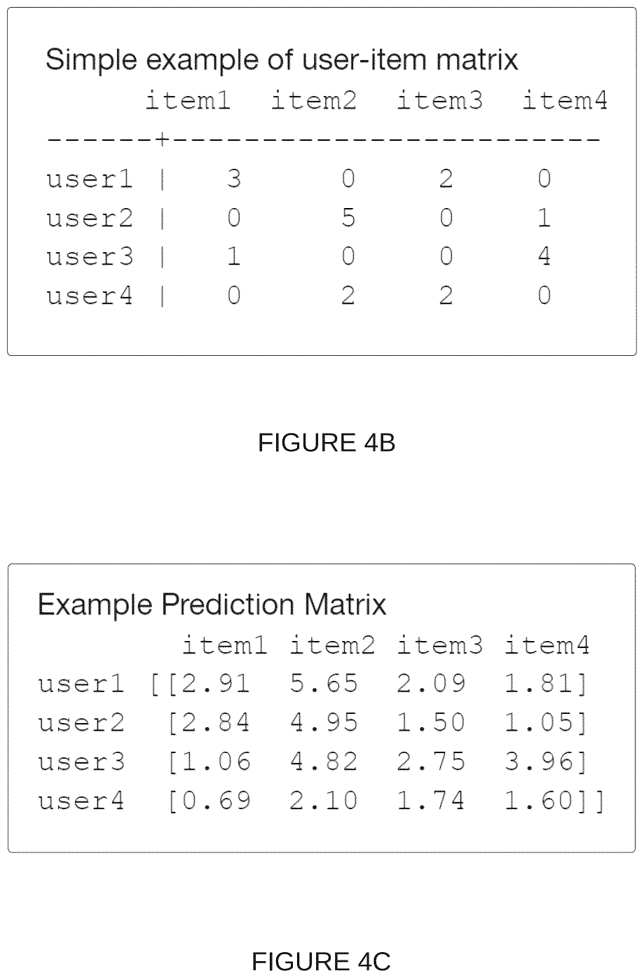

FIG. 4A illustrates examples of data that can be generated and/or registered by the primary service (e.g., in the form of logs or events register). As illustrated, the data can comprise contextual data such as date and time at which the events were registered. The data can also include a description of the event such as the type of event (e.g., search, voice input, etc.). The data can also include any data provided with the input. For example, the data can comprise any search terms indicated by a user such as the text “Lady Gaga” and/or the individual terms “Lady” and “Gaga”. The data can comprise any voice input such as the text “play the daily in spotify” and/or an indication or description of the voice input (e.g., an indication of content or commands indicated with the voice input). The data can include indications of any selection made by the user such as a selection of a search result, a selection of a playback device, a selection of an option to group/ungroup playback devices for synchronous playback, a volume adjustment, etc. The data can include indications of a device that received the input and/or the device that is to execute an action in response to the input.

With reference back to FIG. 3, at block 303, flowchart 300 comprises providing a response based on the event or input. Block 303 can comprise taking an action, and/or causing the media playback system to take an action based on the input. For example, if the input comprises an indication of a command to be executed by the media playback system (e.g., the input comprises a selection of a play button), block 303 can comprise causing the media playback system to execute the command (e.g., causing the media playback system to start playback). As another example, if the input comprises a playback configuration indication and/or change (e.g., adjustment of volume, grouping/ungrouping playback devices, etc.), block 303 can comprise causing the media playback system to implement the indicated playback configuration and/or change.

In instances in which the input comprises one or more search terms, block 303 can comprise providing one or more search results based on the search terms. The one or more search results can comprise indications of media content available at the one or more secondary services registered with the media playback system.

In instances in which the input comprises a voice command, block 303 can comprise providing a corresponding voice response via one or more playback devices of the media playback system. Alternatively or in combination, block 303 can comprise causing the media playback system to take corresponding action (e.g., execute a command indicated in the voice command).

In some instances, block 303 comprises processing the input with an input processing module, as explained with reference to block 301.

In some instances, providing a response in block 303 comprises the primary service 206 communicating and/or accessing one or more of the secondary services. For example, providing a response in block 303 can comprise sending a request to one or more of the secondary services. The request can comprise a request for data/information, a request for media content, a request to perform a function, etc. Block 303 can also comprise the primary device receiving data/information from one or more of the secondary services. In some instances, the data/information received from the one or more secondary services can be received based on a request sent by the primary service. For example, the data/information can be received in a response to a request sent by the primary service.

The response provided in block 303 can then be based on the data/information received from the one or more secondary services. For example, if the input received in block 301 comprised one or more search terms, the response in block 303 can comprise one or more search results from any one or more secondary services. In a more specific example, if the input comprises search terms for media content such as an artist name or a title, the search results can comprise indications of media content that matched the search terms available at any of the secondary services.

Blocks 301, 302 and 303 can be executed any number of times and for any number of inputs. In this way, data can be stored for any number of events/inputs and any period of time. Data stored over time can be aggregated and/or processed to determine trends and perform functions such as characterization of a user profile. In some instances, the primary service 206 can implement or otherwise use a machine learning algorithm 206b to infer trends, patterns, habits, routines, preferences, etc. based on at least part of the stored data. The inferences of the machine learning algorithm can be used to generate a preferences profile for the user.

The data stored in block 302 can be used to generate one or more playback recommendations. For example, the data can indicate that a user frequently searches news podcasts in the morning and plays them back in the kitchen at a particular volume range. A recommendation can be provided to this user in the mornings for a news podcast in the kitchen speaker at the particular volume range. As another example, the data can indicate that the user frequently asks for relaxing music in the evening in the bedroom. A recommendation of relaxing music in the bedroom can then be provided to the user. As another example, the data can indicate that the user usually turns up the volume when a particular kind of music is being played back. A recommendation of the particular volume at the particular volume can then be provided to the user. Recommender service 206c can use data from prior interactions with the media playback system and/or primary service 106.

In some instances, the playback recommendations can be provided based on other information available to the system, in addition to or instead of the data stored in block 302. For example, information about user predefined configurations such as zone scenes, routines or alarms could be used to provide or refine the recommendations. Routines are described in U.S. patent application Ser. No. 17/953,896, filed Sep. 27, 2022, entitled “Routines for Playback Devices”, which is incorporated by reference herein in its entirely. As another example, profile information such as the user age could be used to provide more relevant or appropriate playback recommendations. As another example, account information such as the type of account (family or individual, adult or children, personal or business) could be used to provide more tailored recommendations for particular purposes.

In some instances, a preferences profile can be generated based on aggregated data and the playback recommendations can be based on such preferences profile. The preferences profile can comprise and/or be derived from a preferences matrix. The preferences matrix can include data points indicative of one or more weighted preferences for a particular user. The preferences matrix can be updated as the user interacts with the primary service and more data can be obtained, processed and/or aggregated.

In some instances, a content-based approach can be used to find media items that are similar and/or related to the media items indicated by the user's history of interactions with the system (e.g., events record, playback history, search history, history of voice interactions, etc.). A media item can be characterized by one or more features, such as popularity, genre, era, mood, tempo, etc. Each of these features can be further characterized by additional data. For example, popularity can be personalized with location (e.g., geographic location such as country, city, state, zip code, region, commercial location) and time-of-day contextual information. As a practical example, the popularity value for a user from the United Kingdom (UK) could only be based on the popularity of the item in the UK.

In some instances, similarity between items can be computed using similarity algorithms. For example, the similarity algorithms can determine “pairwise” similarity between items. In some instances, the similarity can be computed using metrics or measurements of similarity between vectors (and/or embedded data) characterizing the items. For example, the similarity between items can be computed using metrics such as cosine-similarity, which can measure similarity between two vectors by determining whether the vectors are pointing in substantially the same direction. As another example, the similarity between items can be computed using metrics such as word-embeddings to obtain the “items' pairwise-similarity” by determining similar words that represent different items. The similar items can then be determined using one or more algorithms. For example, similar items can be found using a clustering algorithm (such as K-means), or with the K-nearest-neighbor algorithm, among others.

With more data from the users, the system could leverage other mechanisms such as collaborative filtering (CF) to predict the user's preferences using the playback history of other users. One example type of collaborative filtering includes user-based, which can recommend items from the playback history of other like-minded users. Another example type of collaborative filtering includes item-based, which recommends items liked by the same group of users. Both example collaborative filtering mechanisms can start with a user-item matrix where the elements in the matrix show the preference of the user for the item. The preference can be an explicit rating given by the user, or inferred based on how often the user interacts with the item (e.g. playback frequency).

FIG. 4B includes an example user-item matrix. In the example of FIG. 4B, a higher number represents a stronger preference, so that user2 prefers item2 to item4, for example. A zero can indicate that the system has no data from the user for that item. Matrix factorization can be used on the user-item matrix to create latent features, which could describe a hidden relationship between users and items. These features can be utilized (e.g., by a recommendation service) to predict a user's preference for a specific item.

For the example illustrated with reference to FIG. 4B, matrix factorization can be used to create a prediction matrix as shown in FIG. 4C. The prediction matrix in FIG. 4C can be obtained using any suitable matrix factorization algorithm. For example, the user-item matrix in FIG. 4B can be decomposed in one or more matrices, one of which (or a product of which) can result in the prediction matrix in FIG. 4C. Alternatively or in combination, the user-item matrix of FIG. 4B can be processed by a machine learning algorithm trained to produce prediction matrices in order to obtain the prediction matrix of FIG. 4C.

As illustrated in the example of FIG. 4C, the predicted value is very similar to the original matrix (e.g. user1, item1, original value is 3, predicted value is 2.91). For elements with a zero-value, the value in the prediction matrix can be used to estimate the user's preference. For example, the example prediction considers that user1 would prefer item2 to item4 (5.65 vs 1.81), and user3 would prefer item2 to item3 (4.82 vs 2.75). The results from the prediction matrix can then be used to generate the recommendations and/or to assess the strength or potential success of a recommendation.

In some instances, a hybrid approach can be used to combine the results from the content-based method and collaborative filtering to provide more accurate recommendations. Additional techniques like deep-learning can be used to model complex preference relationships, recursive neural-networks can model temporal changes in preferences, and reinforcement learning can provide more explorative and serendipitous recommendations.

The examples provided with reference to FIGS. 4B and 4C involve content recommendations, but can be generally applicable to any kind of recommendations such as playback configuration recommendations. The playback configuration recommendations can be provided based on related data previously stored by the system. A user-configuration matrix could be generated to represent the user relationship or preference to particular configurations (e.g., volume, grouping of playback devices, lighting, equalization, etc.). This matrix can be used to generate a prediction matrix to infer and/or recommend playback configurations to the users.

Referring back to FIG. 3, at block 304, flowchart 300 comprises detecting that a new service (e.g., a new streaming service) has been registered with the media playback system and/or with the primary service 206. The new service can be a new secondary service, different from any other secondary service. In some instances, the new secondary service is a first party service provided by the media playback system provider while the other secondary services are third party services provided by providers different than the media playback system provider. In some instances, the credentials to access the new secondary service are the same as the credentials to access the primary service, while the credentials to access the other secondary services are different. The new service can be registered with the media playback system, for example via any of the techniques described in U.S. Pat. No. 8,910,265, filed Sep. 28, 2012, entitled “Assisted Registration of Audio Sources”, incorporated by reference above.

At block 305, flowchart 300 comprises generating one or more playback recommendations for the new secondary service. The one or more playback recommendations can be generated as described before, based on the data stored in block 302. In some instances, the one or more playback recommendations can be generated using one or more machine learning systems/services and/or one or more recommender systems/services, such as such as machine learning service 206b and recommender service 206c illustrated in FIG. 2. The machine learning service 206b and recommender service 206c can be systems/services implemented at least in part by any of the primary service 206, the media playback system, and/or the new secondary service (or particular secondary service for which recommendations are being generated).

In some instances, the recommender service can receive at least part of the data as input and provide recommendations based on the raw data. In other instances, the recommender system(s) can receive data derived from the raw data and provide the recommendations based on this derived data. For example, a pre-processing module can process the data and generate drivers for the recommender service. As another example, the data can be processed by a machine learning algorithm 206b to infer trends, routines and/or preferences. The result of the machine learning algorithm can then be used by the recommender system to provide the one or more recommendations.

The primary service can have access to a catalog of available content from the new secondary service to map the inferences/recommendations to the content available at this new service. The primary service can alternatively or in combination provide the inferences and/or recommendations to the new service so that the new service maps them to the content available. The primary service can obtain content from the new service based at least in part on the generated recommendations and combine the content recommendations with other recommendations (e.g., playback configuration recommendations) to provide a full set of playback recommendations. For example, the primary service can generate/provide a recommendation of a particular content, to be played back by a particular group of playback device, at a particular volume, at a particular time of the day.

At block 306, flowchart 300 comprises providing the one or more playback recommendations via a user interface. The user interface can be a user interface associated with the primary service. In some instances, the user interface is the same user interface via which the input was received in block 301. In some instances, the recommendations are provided via a second user interface which is different from the first user interface of the primary service. For example, the recommendations can be provided via a user interface of the new secondary service.

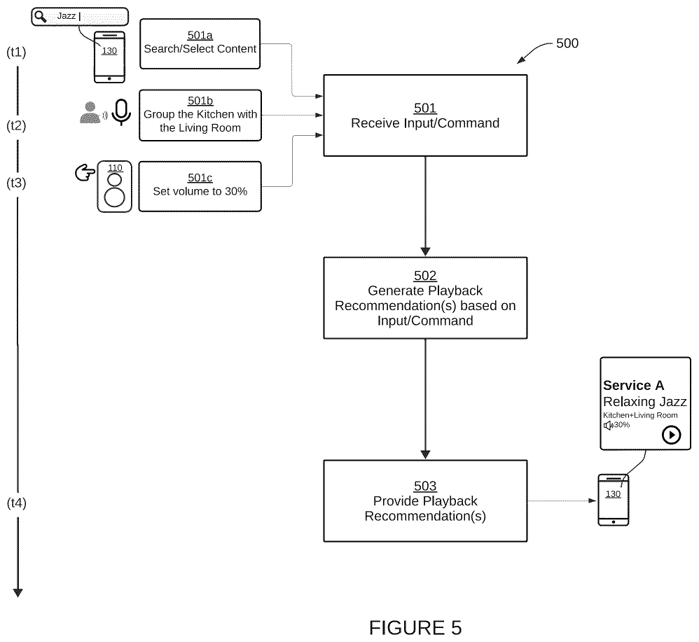

Flowchart 300 describes a process via which playback recommendations are provided for a new secondary service. However, playback recommendations can be provided at any time, regardless of any new secondary service being added to the media playback system, as will be explained in more detail with reference to FIG. 5.

FIG. 5 illustrates a flowchart for a set of example methods of providing playback recommendations based on one or more inputs and/or commands, in accordance with embodiments described herein. FIG. 5 also illustrates a schematic representation of example commands and recommendations, in accordance with some examples.

At block 501, flowchart 500 comprises receiving one or more inputs and/or commands. The inputs and/or commands can correspond to functions to be performed by the media playback system and/or the primary service 206. In some instances, block 501 can comprise receiving, by the primary service 206, command/input data corresponding to one or more commands/inputs received via the media playback system. The commands/input can correspond to commands to be executed by the media playback system, the primary service 206, and/or any of the secondary services 207. In some instances, block 501 can be the same or similar to block 301 described with reference to FIG. 3. In this way, after executing block 501, the primary service can register data corresponding to inputs/commands (similar to block 302 in FIG. 3) and/or provide a response based on the input/command (similar to block 303 in FIG. 3).

FIG. 5 illustrates a set of example inputs/commands 501a, 501b, and 501c that can be received via the media playback system at block 501. As illustrated, the inputs/commands can be received via one or more different user interfaces. For example, a first input 501a can be received via a first user interface. The first user interface can comprise a search interface displayed on the control device 130. The search interface can be provided by primary service 206 and enable a user to search media content for playback. As explained before, the primary service can use the search input/terms to find relevant search results from any of the secondary services 207. As another example, a second input 501b can be received via second, different user interface. The second user interface can comprise a voice user interface of the media playback system. For example, a microphone on any of the playback devices and/or control devices of the media playback system. As another example, a third input 501c can be received via third, different user interface. The third user interface can comprise a hardware interface of the playback device. Other examples of suitable user interfaces are possible.

As illustrated in FIG. 5, different commands can be received at different points in time. In the illustrated example, the first command 501a can be received at a first time t1, the second command 501b can be received at a second time t2, and the third command 501c can be received at a third time t3. The time interval between commands can be any value such as fraction of seconds, seconds, minutes, hours, days, months, years, etc.

Commands can be related to each other and/or related to the same playback session or content. For example, a user can search media content for playback via command 501a and initiate a playback session of particular content. While playing back the particular content or otherwise while still in the same playback session, the user can select playback devices for playback (e.g., group/ungroup devices via command 501b). While still playing back the particular content or otherwise while still in the same playback session, a user can make other adjustments such as adjusting the playback volume via command 501c. However, commands may not necessarily be related to the same playback session. In this way, commands 501a, 501b and 501c can be issued on different days and related to different playback sessions and/or content.

At block 502, flowchart 500 comprises generating one or more playback recommendations. The playback recommendations can be generated based on the input/command data received in block 501. In some instances, block 502 can be the same or similar to block 305 described with reference to FIG. 3. In this way, the playback recommendations generated in block 502 can be generated based on data registered for the inputs/commands received in block 501. Similarly, the playback recommendations generated in block 502 can be generated using one or more machine learning algorithms and/or recommendation systems such as systems 206b and 206c in FIG. 2.

At block 503, flowchart 500 comprises providing the one or more playback recommendations. The one or more playback recommendations can be provided via any user interface, such as any user interface of the media playback system. In some instances, the one or more playback recommendations can be provided via a user interface different than the user interface via which the commands/inputs were received in block 501. For example, the one or more playback recommendations can be provided via a user interface of a new secondary service associated with the media playback system. As illustrated in FIG. 5, the one or more playback recommendations can be provided at a point in time (t4) different than when the inputs/commands where received.

As a practical example of applicability of the methods in FIG. 5, a user could use their controller device (or other user device registered with the media playback system or primary service) to search for a particular type of music (e.g., blues music). The user can search for this music at a first time (or multiple times over a period of time such as over a month or a year). At another time (or multiple other times), the user can issue a voice command to play back classical music. At another time (or multiple other times), the user can use the volume button to set the volume to 30%. Each of these interactions can be stored and/or registered in a data log, an event register, or elsewhere as described before in this disclosure. In this way, when the user adds a new service to their media playback system, the stored data that indicates the user listens to (and/or potentially likes) blues and classical music can be used to provide cold start recommendations of content. Similarly, the stored data that indicates the user listens to particular content at a certain volume level can be used to provide cold start recommendations of volume. Similarly, the stored data that indicates the user listens to particular content in a particular room can be used to provide cold start recommendations of playback devices where content could be played back. The recommender service can suggest content or playback configurations that other listeners of blues and classical music like. For example, the recommender service can suggest jazz, with equalization settings that other users with similar playback activity often use. Other examples are possible.

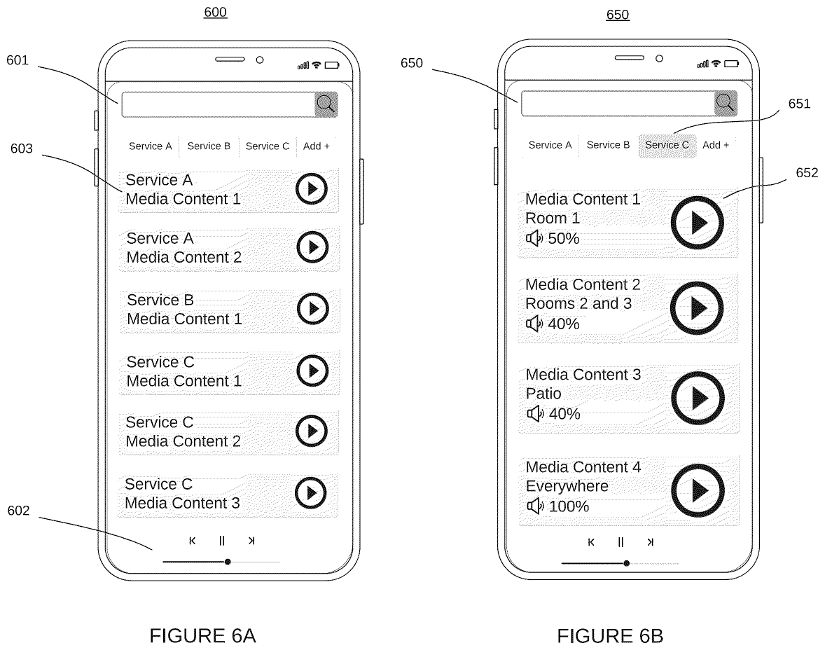

FIGS. 6A and 6B illustrate example user interfaces, in accordance with embodiments described herein. FIG. 6A illustrates an example of a first user interface 600 via which inputs/commands can be received (e.g., as described in blocks 301 and/or 501 of flowcharts 300 and 500, respectively). User interface 600 can be a user interface of the primary service 206. User interface 600 can be a user interface of a controller application of the media playback system. For example, user interface 600 can be an instance of user interface 133 described with reference to FIG. 1H. As illustrated, user interface 600 can provide a set of functionalities such as a search service or search user interface 601 and playback controls 602 (e.g., play, pause, skip, etc.).

The user interface can be configured to receive the one or more inputs from a user. For example, the search interface 601 can be configured to receive one or more search terms. As another example, a search button can be configured so that, when selected, they cause the primary service to execute the corresponding command (e.g., conduct the corresponding search based on the search terms). As another example, the playback controls can be configured so that, when selected, they cause the media playback system to execute the corresponding command.

As explained before, one or more search results 603 can be provided based on the search terms. The search results 603 illustrated in FIG. 6A comprise an indication of the service that provides the indicated media content, such as Service A, B and C. Services A, B and C can be example secondary services 207 registered with the media playback system. As illustrated and as described before, the search results can include results comprising indications of media content available at any of the secondary services registered with the media playback system. The media content indicated in the different search results can be associated with one or more common attributes and/or metadata such as a title, an artist, a genre, a mood, a duration, etc. For example, the search results can be provided based on a search for a song title. In this way, the search results can indicate media content associated with the searched title from the different secondary services. In some instances, different search results can comprise indications of a same media item as available across the different secondary services. In some instances, the search results comprise indications of similar media content available across the different secondary services.

FIG. 6B illustrates an example of a second user interface 650 via which one or more recommendations can be provided (e.g., as described in blocks 306 and/or 503 of flowcharts 300 and 500, respectively). User interface 650 can be a user interface of the primary service 206. User interface 650 can be a user interface of a controller application of the media playback system. For example, user interface 650 can be provided by selecting a particular tab, such as tab 651 in the user interface of the primary service/controller application. In other instances, user interface 650 can be a user interface of the secondary service for which recommendations are being provided.

As illustrated, a set of recommendations can be provided comprising one or more recommendations 652. The recommendations can include content recommendations and playback configuration recommendations such as grouping of playback devices and volume. In this way, the user can be provided with a set of recommendations based on routines, habits or preferences as inferred from the previous inputs received for the primary service.

As mentioned before, the playback recommendations can comprise a recommendation for content and/or a recommendation for a playback configuration. In some instances, the playback recommendations comprise one or more of a media content recommendation, a playback device selection recommendation, and a volume recommendation. The playback recommendation can also or alternatively include equalization recommendations, lighting recommendations, scent recommendations, recommendations of content in different media format, or any other type of recommendations suitable for the particular media playback system.

In some instances, the playback recommendations can be based on previous interactions of the user with the primary service, but not necessarily with the secondary services. Furthermore, the playback recommendations can be based on contextual data registered as part of the log data and/or available to the primary service provider. In this way, even if the primary service is unaware of the content that users ultimately play back via any of the secondary services, the primary service can leverage its proprietary information to provide meaningful playback recommendations.

Users can be provided with the option to enable/disable this service and control the type of information that the primary service provider registers in its logs and/or uses for recommendation purposes. Furthermore, since the playback recommendations are generated locally by the primary service, user data can remain private and safe, while still being used to provide meaningful playback recommendations and enhance the user experience.

In some instances, the selection of one of the one or more playback recommendations causes the primary or secondary service to modify, refine, and/or apply weight to the recommendations. For example, selecting one of the search results can cause the search results to be ranked differently. Furthermore, the selection can be used to feed back to the recommender system so that the weights applied to other recommendations consider the user selection. In this way, additional interactions can continue to be used to generate playback recommendations.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing system comprising:
at least one processor; and
at least one non-transitory computer-readable medium comprising program instructions that are executable by the at least one processor such that the computing system is configured to:
receive, via a first service registered with a media playback system, a first input comprising one or more search terms;
after receiving the first input: (i) store first data corresponding to the first input, and (ii) provide one or more search results based on the one or more search terms, wherein the one or more search results comprise indications of media content available at one or more streaming services registered with the media playback system;
receive, via the first service, a second input indicating a playback configuration for the media playback system; and
after receiving the second input: (i) store second data corresponding to the second input; and (ii) cause the media playback system to implement the playback configuration;
detect that a new streaming service has been registered with the media playback system, wherein the new streaming service is different from the one or more streaming services; and
based on the first data and the second data, generate one or more playback recommendations for the new streaming service, wherein the one or more playback recommendations comprise at least one media content recommendation based on the one or more search terms and at least one playback configuration recommendation based on the playback configuration.

2. The computing system of claim 1, wherein the first input is received via a first user interface, and the at least one non-transitory computer-readable medium further comprises program instructions such that the computing system is configured to:
provide the one or more playback recommendations via a second user interface corresponding to the new streaming service, wherein the second user interface is different from the first user interface.

3. The computing system of claim 1, wherein the second input indicating the playback configuration comprise one or more of: an indication of a playback device which is to play back media content, an indication of a volume at which media content is to be played back, an indication of an equalization setting, or a configuration change to one or more aspects of the media playback system.

4. The computing system of claim 3, wherein the at least one playback configuration recommendation comprises one or more of: a recommendation of a playback device which is to play back media content, a recommendation of a volume at which media content is to be played back, a recommendation of an equalization setting, or a recommendation of a change to one or more aspects of the media playback system.

5. The computing system of claim 1, wherein the first input indicates media content metadata.

6. The computing system of claim 5, wherein the media content metadata comprises one or more of: a media item title, an artist name, an album name, a genre, or a mood.

7. The computing system of claim 1, wherein:
the one or more streaming services comprise at least one first streaming service and at least one second streaming service; and
the one or more search results comprise at least one first indication of first media content available at the at least one first streaming service and at least one second indication of second media content available at the at least one second streaming service.

8. The computing system of claim 7, wherein the one or more playback recommendations comprise at least one third indication of third media content available at the new streaming service.

9. The computing system of claim 8, wherein the first media content, second media content, and third media content have at least one common attribute.

10. The computing system of claim 8, wherein the first media content, second media content, and third media content comprise the same media content.

11. The computing system of claim 1, wherein detecting that the new streaming service has been registered with the media playback system comprises:
receiving, from a control device of the media playback system, one or more requests to register the new streaming service with the media playback system; and
based on the one or more requests, register the new streaming service with the media playback system.

12. The computing system of claim 1, wherein generating the one or more playback recommendations for the new streaming service based on the first data and the second data comprises generating a preferences profile based on the first data and the second data.

13. The computing system of claim 12, wherein generating the preferences profile based on the first data and the second data comprises determining one or more patterns in the first data and the second data.

14. The computing system of claim 1, wherein generating the one or more playback recommendations for the new streaming service based on the first data and the second data comprises:
aggregating the first data and the second data;
generating a preferences profile based on the aggregated first data and the second data; and
generating the one or more playback recommendations based on the preferences profile.

15. The computing system of claim 1, wherein generating the one or more playback recommendations for the new streaming service comprises providing at least part of a log data to a recommender system, wherein the recommender system has access to a catalog of media content available at the new streaming service.

16. The computing system of claim 1, wherein the at least one non-transitory computer-readable medium further comprises program instructions such that the computing system is configured to:
after providing the one or more search results, receive a selection of a particular search result from the one or more search results; and
updating the one or more playback recommendations based on the selection of the particular search result.

17. The computing system of claim 16, wherein updating the one or more playback recommendations comprises ranking the one or more playback recommendations based on the selection of the particular search result.

18. The computing system of claim 16, wherein the at least one non-transitory computer-readable medium further comprises program instructions such that the computing system is configured to register log data corresponding to the selection.

19. A computer-implemented method executed by a processor at a media playback system, the computer-implemented method comprising:
receiving, via a first service registered with the media playback system, a first input comprising one or more search terms;
after receiving the first input: (i) storing first data corresponding to the first input, and (ii) providing one or more search results based on the one or more search terms, wherein the one or more search results comprise indications of media content available at one or more streaming services registered with the media playback system;
receiving, via the first service, a second input indicating a playback configuration for the media playback system; and
after receiving the second input: (i) storing second data corresponding to the second input; and (ii) causing the media playback system to implement the playback configuration;
detecting that a new streaming service has been registered with the media playback system, wherein the new streaming service is different from the one or more streaming services; and
based on the first data and the second data, generating one or more playback recommendations for the new streaming service, wherein the one or more playback recommendations comprise at least one media content recommendation based on the one or more search terms and at least one playback configuration recommendation based on the playback configuration.

20. A non-transitory computer-readable storage media having stored thereon computer-executable instructions that, when executed at a processor of a media playback system, cause the media playback system to:
receive, via a first service registered with the media playback system, a first input comprising one or more search terms;
after receiving the first input: (i) store first data corresponding to the first input, and (ii) provide one or more search results based on the one or more search terms, wherein the one or more search results comprise indications of media content available at one or more streaming services registered with the media playback system;
receive, via the first service, a second input indicating a playback configuration for the media playback system; and
after receiving the second input: (i) store second data corresponding to the second input; and (ii) cause the media playback system to implement the playback configuration;
detect that a new streaming service has been registered with the media playback system, wherein the new streaming service is different from the one or more streaming services; and
based on the first data and the second data, generate one or more playback recommendations for the new streaming service, wherein the one or more playback recommendations comprise at least one media content recommendation based on the one or more search terms and at least one playback configuration recommendation based on the playback configuration.
